(19) United States
(12) Patent Application Publication
(10) Pub. No.: US 2016/0266886 A1
(43) Pub. Date: Sep. 15, 2016

(54) PERFORMING A VEHICLE UPDATE

(71) Applicant: GM Global Technology Operations LLC, Detroit, MI (US)

(72) Inventors: Susanta P. Sarkar, Rochester Hills, MI (US); Karin L. Turski, Rochester Hills, MI (US)

(21) Appl. No.: 14/643,403

(22) Filed: Mar. 10, 2015

(51) Int. Cl. G06F 9/445; H04L 29/08

(52) U.S. Cl. CPC G06F 8/65; H04L 67/34; G06F 8/61; H04L 67/12

(57) ABSTRACT

A mobile vehicle communications system and method for performing a software update at a vehicle. The method carried out by the system includes the steps of: providing a vehicle user of an update availability message associated with a vehicle electronic control unit (ECU); receiving a vehicle user consent to install the update; determining whether a vehicle ignition OFF condition is TRUE; when the vehicle ignition OFF condition is TRUE, then installing the update; and providing a notification to a mobile device associated with the vehicle user that the installation is complete.

### TECHNICAL FIELD

The present invention relates to performing a vehicle update, and more particularly, to performing the update for an electronic control unit in a vehicle.

### BACKGROUND

Vehicle manufacturers may utilize remote computing to deliver software and/or firmware to electronic control units or other electronic devices in the vehicle. A remote server may transmit cellular data to the vehicle, e.g., during periods of low network activity. Upon receipt, the vehicle may install the updates.

### SUMMARY

According to an embodiment of the invention, there is provided a method of performing a software update at a vehicle. The method includes the steps of: providing a vehicle user of an update availability message associated with a vehicle electronic control unit (ECU); receiving a vehicle user consent to install the update; determining whether a vehicle ignition OFF condition is TRUE; when the vehicle ignition OFF condition is TRUE, then installing the update; and providing a notification to a mobile device associated with the vehicle user that the installation is complete.

According to another embodiment of the invention, there is provided a method of performing a software update at a vehicle. The method includes the steps of: receiving an update availability message associated with an update for a vehicle electronic control unit (ECU); providing a vehicle user of the update availability message using a vehicle multi-tainment unit (VMU); determining that a vehicle ignition OFF condition is TRUE; prompting the user to install the update; when an indication is received that the user wishes to install the update: determining whether a vehicle parked condition is TRUE, and when the vehicle ignition condition and the vehicle parked condition are TRUE, then installing the update; and providing a notification from the VMU to a mobile device associated with the user that the installation is complete.

According to another embodiment of the invention, there is provided a method of performing a software update at a vehicle. The method includes the steps of: providing an update availability message after downloading the software update using a vehicle telematics unit or a vehicle multi-tainment unit (VMU); determining whether a vehicle ignition OFF condition is TRUE; when the vehicle ignition OFF condition is TRUE, then installing the update; inhibiting vehicle ignition during the installing step; and providing a notification from the VMU to a mobile device associated with a user of the vehicle that the installation is complete.

### BRIEF DESCRIPTION OF THE DRAWINGS

One or more embodiments of the invention will hereinafter be described in conjunction with the appended drawings, wherein like designations denote like elements, and wherein:

FIG. 1 is a block diagram depicting an embodiment of a communications system that is capable of utilizing the method disclosed herein;

FIG. 2 is a schematic diagram of a portion of the communications system of FIG. 1;

FIG. 3 is a flow diagram illustrating a method of using the communications system; and

FIGS. 4A-4B is another flow diagram illustrating another method of using the communications system.

### DETAILED DESCRIPTION OF THE ILLUSTRATED EMBODIMENT(S)

Several methods are described below pertaining to: (1) providing a software update (e.g., for an electronic control unit or ECU in a vehicle); and (2) providing a vehicle user a notification that the software update is completely downloaded and installed. The methods may be used to improve the user's vehicle experience. For example, software updates can be time-consuming. The methods may be primarily performed in the user's absence. In addition, the notification(s) may be provided when the update installation is complete, thereby notifying the user that the update has been done and/or that the vehicle is free to be used again.

### Communications System—

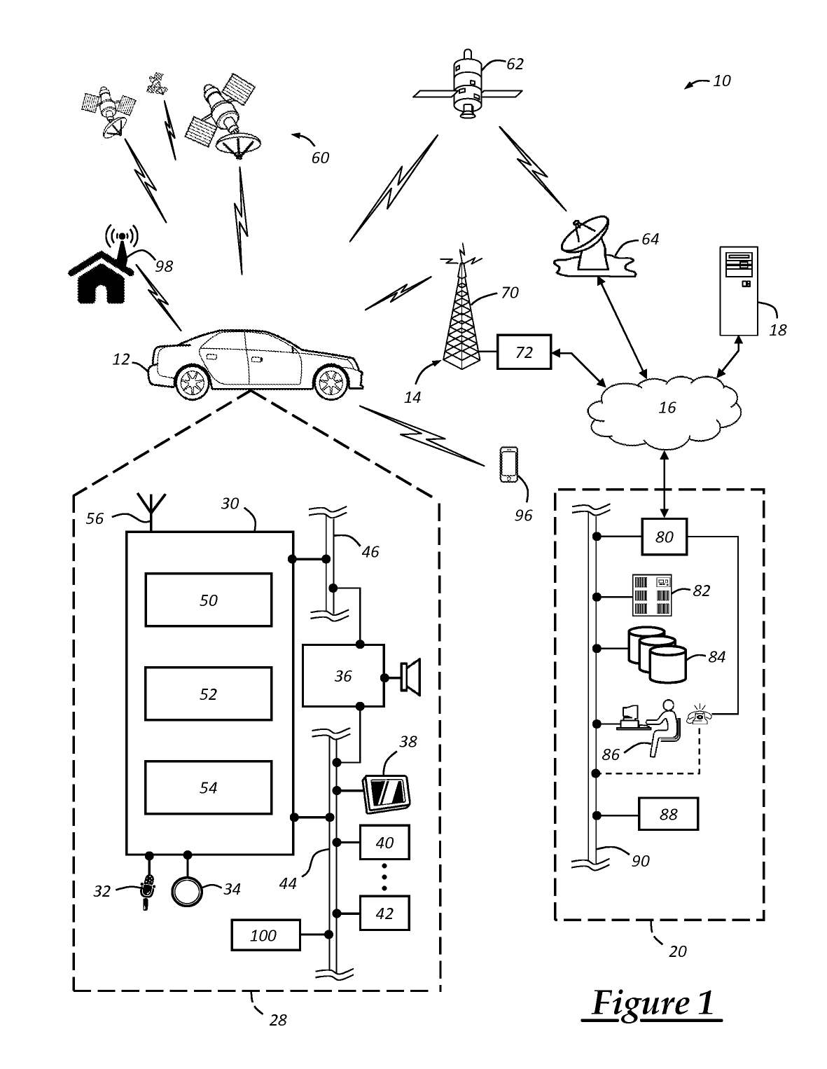

With reference to FIG. 1, there is shown an operating environment that comprises a mobile vehicle communications system 10 and that can be used to implement the method disclosed herein. Communications system 10 generally includes a vehicle 12, one or more wireless carrier systems 14, a land communications network 16, a computer 18, and a call center 20. It should be understood that the disclosed method can be used with any number of different systems and is not specifically limited to the operating environment shown here. Also, the architecture, construction, setup, and operation of the system 10 and its individual components are generally known in the art. Thus, the following paragraphs simply provide a brief overview of one such communications system 10; however, other systems not shown here could employ the disclosed method as well.

Vehicle 12 is depicted in the illustrated embodiment as a passenger car, but it should be appreciated that any other vehicle including motorcycles, trucks, sports utility vehicles (SUVs), recreational vehicles (RVs), marine vessels, aircraft, etc., can also be used. Some of the vehicle electronics 28 is shown generally in FIG. 1 and includes a telematics unit 30, a microphone 32, one or more pushbuttons or other control inputs 34, an audio system 36, a visual display 38, and a GPS module 40 as well as a number of vehicle system modules (VSMs) 42. Some of these devices can be connected directly to the telematics unit such as, for example, the microphone 32 and pushbutton(s) 34, whereas others are indirectly connected using one or more network connections, such as a communications bus 44 or an entertainment bus 46. Examples of suitable network connections include a controller area network (CAN), a media oriented system transfer (MOST), a local interconnection network (LIN), a local area network (LAN), and other appropriate connections such as Ethernet or others that conform with known ISO, SAE and IEEE standards and specifications, to name but a few.

Telematics unit 30 can be an OEM-installed (embedded) or aftermarket device that is installed in the vehicle and that enables wireless voice and/or data communication over wireless carrier system 14 and via wireless networking. This enables the vehicle to communicate with call center 20, other telematics-enabled vehicles, or some other entity or device. The telematics unit preferably uses radio transmissions to establish a communications channel (a voice channel and/or a data channel) with wireless carrier system 14 so that voice and/or data transmissions can be sent and received over the channel. By providing both voice and data communication, telematics unit 30 enables the vehicle to offer a number of different services including those related to navigation, telephony, emergency assistance, diagnostics, infotainment, etc. Data can be sent either via a data connection, such as via packet data transmission over a data channel, or via a voice channel using techniques known in the art. For combined services that involve both voice communication (e.g., with a live advisor or voice response unit at the call center 20) and data communication (e.g., to provide GPS location data or vehicle diagnostic data to the call center 20), the system can utilize a single call over a voice channel and switch as needed between voice and data transmission over the voice channel, and this can be done using techniques known to those skilled in the art.

According to one embodiment, telematics unit 30 utilizes cellular communication according to either GSM or CDMA standards and thus includes a standard cellular chipset 50 for voice communications like hands-free calling, a wireless modem for data transmission, an electronic processing device 52, one or more digital memory devices 54, and a dual antenna 56. It will be appreciated that GSM or CDMA standards illustrate merely exemplary implementations and other standards are also possible (e.g., LTE). It should be appreciated that the modem can either be implemented through software that is stored in the telematics unit and is executed by processor 52, or it can be a separate hardware component located internal or external to telematics unit 30. The modem can operate using any number of different standards or protocols such as EVDO, CDMA, GPRS, EDGE, and LTE. When used for packet-switched data communication such as TCP/IP, the telematics unit can be configured with a static IP address or can set up to automatically receive an assigned IP address from another device on the network such as a router or from a network address server. Wireless networking between the vehicle and other networked devices can also be carried out using telematics unit 30. For this purpose, telematics unit 30 can be configured to communicate wirelessly according to one or more suitable wireless protocols. Examples of wireless network(s) include both cellular networks (as previously described) but also short range wireless communication (SRWC). SRWC is intended to be construed broadly and may include one or more suitable wireless protocols including: Near-Field Communication (NFC), any Wi-Fi standard (e.g., IEEE 802.11); Wi-Fi Direct, Bluetooth, Digital Living Network Alliance (DLNA), or other suitable peer-to-peer standard; wireless infrared transmission; WiMAX; ZigBee™; and/or various combinations thereof. This list is merely meant to provide examples and is not intended to be limiting.

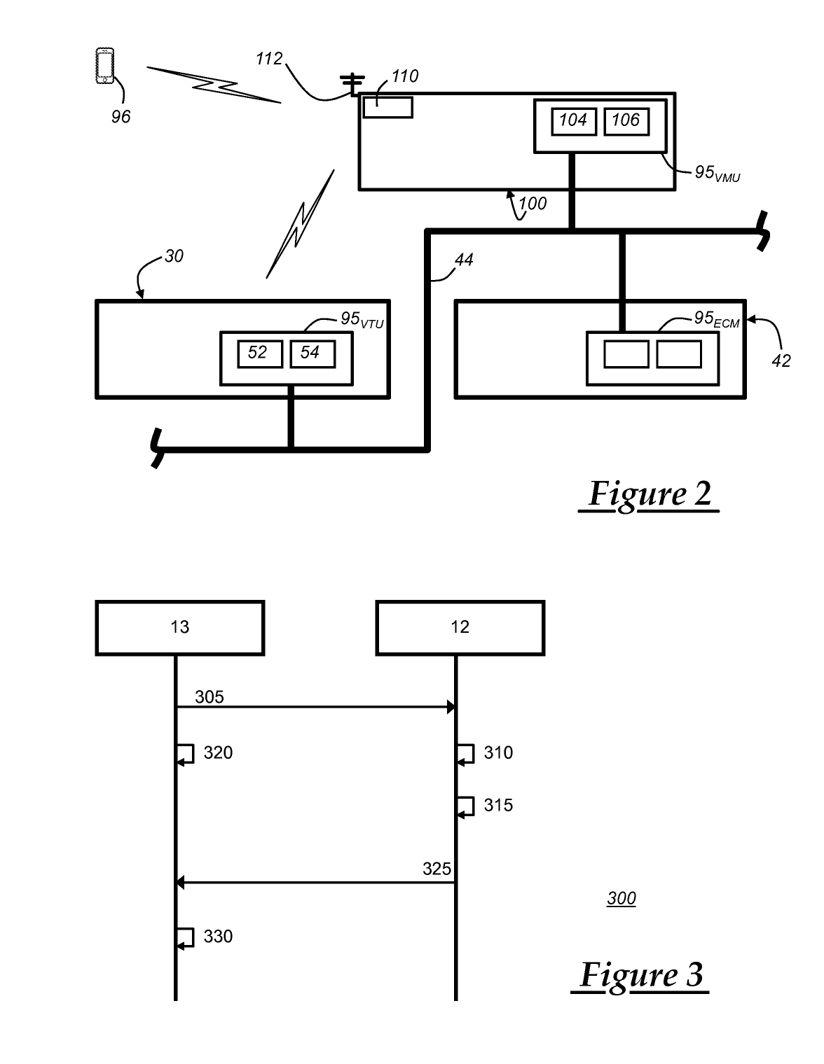

Processor 52 can be any type of device capable of processing electronic instructions including microprocessors, microcontrollers, host processors, controllers, vehicle communication processors, and application specific integrated circuits (ASICs). It can be a dedicated processor used only for telematics unit 30 or can be shared with other vehicle systems. Processor 52 executes various types of digitally-stored instructions, such as software or firmware programs stored in memory 54, which enable the telematics unit to provide a wide variety of services. For instance, processor 52 can execute programs or process data to carry out at least a part of the method discussed herein. Collectively, the processor(s) 52 and memory 54 may be part of a vehicle telematics unit (VTU) electronic control unit (ECU) 95_{VTU} that enables communication over one or more vehicle buses (e.g., 44, 46) (see FIG. 2).

Returning to FIG. 1, telematics unit 30 can be used to provide a diverse range of vehicle services that involve wireless communication to and/or from the vehicle. Such services include: turn-by-turn directions and other navigation-related services that are provided in conjunction with the GPS-based vehicle navigation module 40; airbag deployment notification and other emergency or roadside assistance-related services that are provided in connection with one or more collision sensor interface modules such as a body control module (not shown); diagnostic reporting using one or more diagnostic modules; and infotainment-related services where music, webpages, movies, television programs, videogames and/or other information is downloaded by an infotainment module (not shown) and is stored for current or later playback. The above-listed services are by no means an exhaustive list of all of the capabilities of telematics unit 30, but are simply an enumeration of some of the services that the telematics unit is capable of offering. Furthermore, it should be understood that at least some of the aforementioned modules could be implemented in the form of software instructions saved internal or external to telematics unit 30, they could be hardware components located internal or external to telematics unit 30, or they could be integrated and/or shared with each other or with other systems located throughout the vehicle, to cite but a few possibilities. In the event that the modules are implemented as VSMs 42 located external to telematics unit 30, they could utilize vehicle bus 44 to exchange data and commands with the telematics unit.

GPS module 40 receives radio signals from a constellation 60 of GPS satellites. From these signals, the module 40 can determine vehicle position that is used for providing navigation and other position-related services to the vehicle driver. Navigation information can be presented on the display 38 (or other display within the vehicle) or can be presented verbally such as is done when supplying turn-by-turn navigation. The navigation services can be provided using a dedicated in-vehicle navigation module (which can be part of GPS module 40), or some or all navigation services can be done via telematics unit 30, wherein the position information is sent to a remote location for purposes of providing the vehicle with navigation maps, map annotations (points of interest, restaurants, etc.), route calculations, and the like. The position information can be supplied to call center 20 or other remote computer system, such as computer 18, for other purposes, such as fleet management. Also, new or updated map data can be downloaded to the GPS module 40 from the call center 20 via the telematics unit 30.

Apart from the audio system 36 and GPS module 40, the vehicle 12 can include other vehicle system modules (VSMs) 42 in the form of electronic hardware components that are located throughout the vehicle and typically receive input from one or more sensors and use the sensed input to perform diagnostic, monitoring, control, reporting and/or other functions. Each of the VSMs 42 is preferably connected by communications bus 44 to the other VSMs, as well as to the telematics unit 30, and can be programmed to run vehicle system and subsystem diagnostic tests. As examples, one VSM 42 can be an engine control module (ECM) that controls various aspects of engine operation such as fuel ignition and ignition timing, another VSM 42 can be a powertrain control module that regulates operation of one or more components of the vehicle powertrain, and another VSM 42 can be a body control module that governs various electrical components located throughout the vehicle, like the vehicle's power door locks and headlights. According to one embodiment, the ECM is equipped with on-board diagnostic (OBD) features that provide myriad real-time data, such as that received from various sensors including vehicle emissions sensors, and provide a standardized series of diagnostic trouble codes (DTCs) that allow a technician to rapidly identify and remedy malfunctions within the vehicle. Each of the VSMs 42 may have an electronic control unit (ECU) comprising a processor and memory and may interface with one or more vehicle buses 44, 46; e.g., the ECM is shown electrically coupled to the bus 44 having ECU 95_{ECM}. As is appreciated by those skilled in the art, the above-mentioned VSMs are only examples of some of the modules that may be used in vehicle 12, as numerous others are also possible.

Vehicle electronics 28 also includes a number of vehicle user interfaces that provide vehicle occupants with a means of providing and/or receiving information, including microphone 32, pushbuttons(s) 34, audio system 36, and visual display 38. As used herein, the term ‘vehicle user interface’ broadly includes any suitable form of electronic device, including both hardware and software components, which is located on the vehicle and enables a vehicle user to communicate with or through a component of the vehicle. Microphone 32 provides audio input to the telematics unit to enable the driver or other occupant to provide voice commands and carry out hands-free calling via the wireless carrier system 14. For this purpose, it can be connected to an on-board automated voice processing unit utilizing human-machine interface (HMI) technology known in the art. The pushbutton(s) 34 allow manual user input into the telematics unit 30 to initiate wireless telephone calls and provide other data, response, or control input. Separate pushbuttons can be used for initiating emergency calls versus regular service assistance calls to the call center 20. Audio system 36 provides audio output to a vehicle occupant and can be a dedicated, stand-alone system or part of the primary vehicle audio system. According to the particular embodiment shown here, audio system 36 is operatively coupled to both vehicle bus 44 and entertainment bus 46 and can provide AM, FM and satellite radio, CD, DVD and other multimedia functionality. This functionality can be provided in conjunction with or independent of the infotainment module described above. Visual display 38 is preferably a graphics display, such as a touch screen on the instrument panel or a heads-up display reflected off of the windshield, and can be used to provide a multitude of input and output functions. Various other vehicle user interfaces can also be utilized, as the interfaces of FIG. 1 are only an example of one particular implementation.

The vehicle electronics 28 may also include a communication device such as a vehicle head unit or vehicle multi-tainment unit (VMU) 100 which may include some of the vehicle electronics previously discussed (e.g., the audio system 36, the visual display 38, etc.). Display examples of the VMU include interactive displays in the vehicle instrument panel, interactive displays embedded within the backing of vehicle seating or the vehicle headliner, and other interactive vehicle devices/displays that are portable. Thus, in some instances, the VMU 100 may be integrated (e.g., a fixture) within the vehicle 12 and in some circumstances it may be detachably fixed or detachably tethered (e.g., usable both inside and outside the vehicle).

As shown in both FIGS. 1 and 2, the VMU 100 may include all suitable electronics, software, etc. for providing vehicle entertainment and vehicle infotainment services to the vehicle users and/or occupants including an ECU 95_{VMU} having memory 104 coupled to a processor or processing device 106. The VMU 100 may be coupled to (and in communication with) the telematics unit 30, various other VSMs 42—e.g., by wire (e.g., via bus 44 and/or 46) or wirelessly using a short-range wireless communication (SRWC) chipset 110 and antenna 112.

Additionally, the chipset 110 may be capable of SRWC with other communication devices such as the mobile device 96 (FIG. 1) as well. The SRWC capability of the VMU 100 may enable peer-to-peer communication between the VMU and other devices; and in some instances, the VMU 100 may be a wireless or Wi-Fi hotspot for compatible devices. Also, in some instances, the VMU may be capable of behaving as a SRWC client device; e.g., when the vehicle is within a wireless range of a wireless access point (WAP) that is a wireless hotspot, the VMU may be the client and connect. In Wi-Fi Direct implementations, the VMU may be the group owner or a group member, as those terms are understood by skilled artisans.

Returning to FIG. 1, wireless carrier system 14 is preferably a cellular telephone system that includes a plurality of cell towers 70 (only one shown), one or more mobile switching centers (MSCs) 72, as well as any other networking components required to connect wireless carrier system 14 with land network 16. Each cell tower 70 includes sending and receiving antennas and a base station, with the base stations from different cell towers being connected to the MSC 72 either directly or via intermediary equipment such as a base station controller. Cellular system 14 can implement any suitable communications technology, including for example, analog technologies such as AMPS, or the newer digital technologies such as CDMA (e.g., CDMA2000) or GSM/GPRS. As will be appreciated by those skilled in the art, various cell tower/base station/MSC arrangements are possible and could be used with wireless system 14. For instance, the base station and cell tower could be co-located at the same site or they could be remotely located from one another, each base station could be responsible for a single cell tower or a single base station could service various cell towers, and various base stations could be coupled to a single MSC, to name but a few of the possible arrangements.

Apart from using wireless carrier system 14, a different wireless carrier system in the form of satellite communication can be used to provide uni-directional or bi-directional communication with the vehicle. This can be done using one or more communication satellites 62 and an uplink transmitting station 64. Uni-directional communication can be, for example, satellite radio services, wherein programming content (news, music, etc.) is received by transmitting station 64, packaged for upload, and then sent to the satellite 62, which broadcasts the programming to subscribers. Bi-directional communication can be, for example, satellite telephony services using satellite 62 to relay telephone communications between the vehicle 12 and station 64. If used, this satellite telephony can be utilized either in addition to or in lieu of wireless carrier system 14.

Land network 16 may be a conventional land-based telecommunications network that is connected to one or more landline telephones and connects wireless carrier system 14 to call center 20. For example, land network 16 may include a public switched telephone network (PSTN) such as that used to provide hardwired telephony, packet-switched data communications, and the Internet infrastructure. One or more segments of land network 16 could be implemented through the use of a standard wired network, a fiber or other optical network, a cable network, power lines, other wireless networks such as wireless local area networks (WLANs), or networks providing broadband wireless access (BWA), or any combination thereof. Furthermore, call center 20 need not be connected via land network 16, but could include wireless telephony equipment so that it can communicate directly with a wireless network, such as wireless carrier system 14.

Computer 18 can be one of a number of computers accessible via a private or public network such as the Internet. Each such computer 18 can be used for one or more purposes, such as a web server accessible by the vehicle via telematics unit 30 and wireless carrier 14. Other such accessible computers 18 can be, for example: a service center computer where diagnostic information and other vehicle data can be uploaded from the vehicle via the telematics unit 30; a client computer used by the vehicle owner or other subscriber for such purposes as accessing or receiving vehicle data or to setting up or configuring subscriber preferences or controlling vehicle functions; or a third party repository to or from which vehicle data or other information is provided, whether by communicating with the vehicle 12 or call center 20, or both. A computer 18 can also be used for providing Internet connectivity such as DNS services or as a network address server that uses DHCP or other suitable protocol to assign an IP address to the vehicle 12.

Call center 20 is designed to provide the vehicle electronics 28 with a number of different system back-end functions and, according to the exemplary embodiment shown here, generally includes one or more switches 80, servers 82, databases 84, live advisors 86, as well as an automated voice response system (VRS) 88, all of which are known in the art. These various call center components are preferably coupled to one another via a wired or wireless local area network 90. Switch 80, which can be a private branch exchange (PBX) switch, routes incoming signals so that voice transmissions are usually sent to either the live adviser 86 by regular phone or to the automated voice response system 88 using VoIP. The live advisor phone can also use VoIP as indicated by the broken line in FIG. 1. VoIP and other data communication through the switch 80 is implemented via a modem (not shown) connected between the switch 80 and network 90. Data transmissions are passed via the modem to server 82 and/or database 84. Database 84 can store account information such as subscriber authentication information, vehicle identifiers, profile records, behavioral patterns, and other pertinent subscriber information. Data transmissions may also be conducted by wireless systems, such as 802.11x, GPRS, and the like. Although the illustrated embodiment has been described as it would be used in conjunction with a manned call center 20 using live advisor 86, it will be appreciated that the call center can instead utilize VRS 88 as an automated advisor or, a combination of VRS 88 and the live advisor 86 can be used.

The communication system 10 may also include various wireless access points (WAPs) capable of communicating with vehicle 12—typically using some form of SRWC (e.g., Wi-Fi or Wi-Fi Direct, just to name a couple examples). Non-limiting examples of WAPs include: roadside infrastructure, commercial buildings, private residences, and other suitable establishments, just to name a few examples.

The operating environment may further include one or more handheld communications devices (HCDs) or mobile devices 96. The mobile device may be an electronic device which may be used to make mobile telephone calls across a wide geographic area where transmissions are facilitated by the wireless carrier system 14 (i.e., when the mobile device is connected to the wireless carrier system).

The mobile device may further include: hardware, software, and/or firmware enabling cellular telecommunications and communications via short-range wireless communication (e.g., Wi-Fi, Wi-Fi Direct, and Bluetooth) as well as other mobile device applications. The hardware of the mobile device 96 may comprise: a processor and memory (e.g., non-transitory computer readable medium configured to operate with the processor) for storing the software, firmware, etc. The mobile device processor and memory may enable various software applications, which may be preinstalled or installed by the user (or manufacturer) (e.g., having a software application or graphical user interface or GUI). One commercial implementation of a vehicle-mobile device application may be RemoteLink™, enabling a vehicle user to communicate with the vehicle 12 and/or control various aspects or functions of the vehicle—e.g., among other things, allowing the user to remotely lock/unlock vehicle doors, turn the vehicle On/Off, check the vehicle tire pressures, fuel level, oil life, etc. RemoteLink™ may also allow the user to connect with the call center 20 or the call center advisor 86 at any time.

When using SRWC, the mobile device 96 may be capable of behaving as a client device or as a server device (e.g., Wi-Fi, Bluetooth, etc.). In server device implementations, the mobile device may be a wireless hotspot or wireless access point (WAP) for other compatible devices. In a Wi-Fi Direct environment, the mobile device may suitably be the group owner or a group member, as those terms are understood by skilled artisans.

The mobile device hardware also may include a display, a keypad (e.g., push button and/or touch screen), a microphone, one or more speakers, motion-detection sensors (such as accelerometers, gyroscopes, etc.), and a camera.

In addition to the aforementioned features, modern mobile devices may support additional services and/or functionality such as short messaging service (SMS or texts), multimedia messaging service (MMS), email, internet access, as well as business and gaming applications.

Non-limiting examples of the mobile device 96 include a cellular telephone, a personal digital assistant (PDA), a Smart phone, a personal laptop computer or tablet computer having two-way communication capabilities, a netbook computer, a notebook computer, or any suitable combinations thereof. The mobile device 96 may be used inside or outside of a mobile vehicle (such as the vehicle 12 shown in FIG. 1), and may be coupled to the vehicle by wire or wirelessly (e.g., using short range wireless communication). The mobile device also may be configured to provide services according to a subscription agreement with a third-party facility or wireless/telephone service provider. It should be appreciated that various service providers may utilize the wireless carrier system and that the service provider of the telematics unit 30 may not necessarily be the same as the service provider of the mobile devices 96.

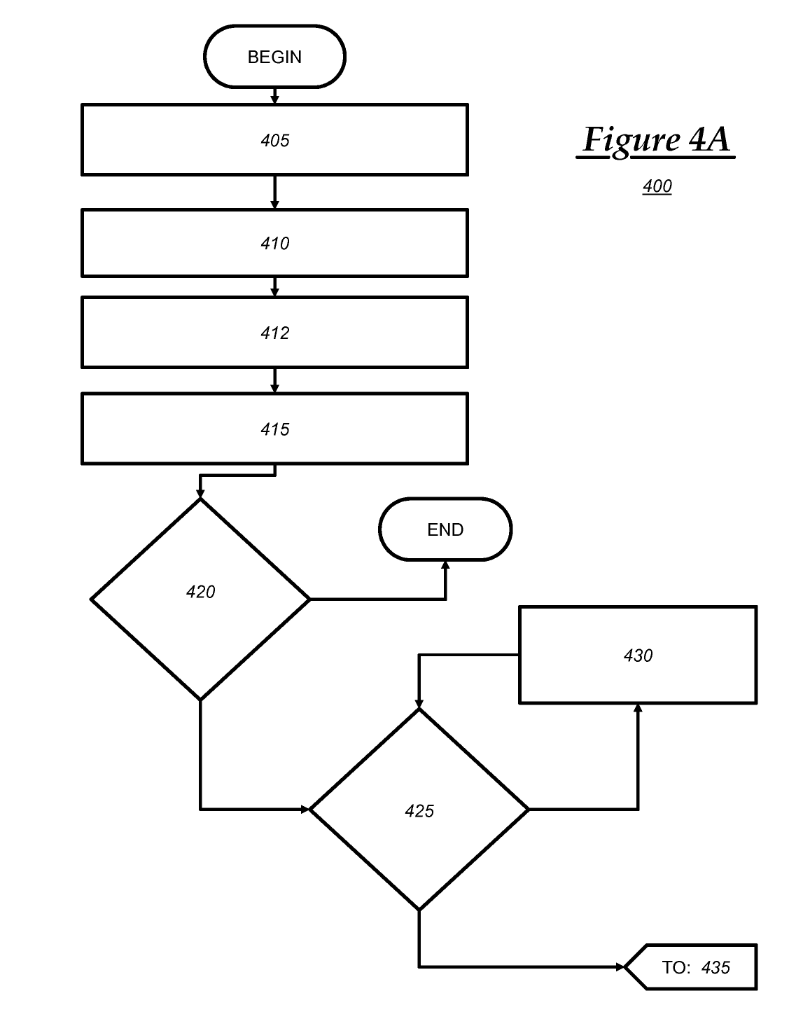

The mobile device 96 and the vehicle 12 may be used together by a person known as the vehicle user 13 (FIG. 3) such as a vehicle driver or a vehicle passenger. However, the vehicle user does not need to have ownership of the mobile device 96 or the vehicle 12 (e.g., the vehicle user may be an owner or a licensee of either or both).

### Method—

Turning now to FIG. 3, there is shown an embodiment of a method 300 for performing a vehicle software update. The update may have been downloaded previously via the VMU 100 or the telematics unit 30. The method begins with step 305 by the user 13 consenting to perform the software update—this may include providing an indication of consent to the vehicle 12 or using vehicle electronics 28. As will be explained more below, the vehicle first may provide a prompt or notification to the user 13 indicating the update is or may be available. The user's indication may be received by the vehicle 12 via a voice command, tactile input, touch screen input, etc. Regardless of how the consent is received, the method may next proceed to step 310.

In step 310, the vehicle 12 may perform a verification process. The verification process may include: receiving the software update at the telematics unit 30 from a remote server (e.g., the computer 18 or from the call center 20) or receiving the update at the VMU 100 via SRWC or other suitable communication; comparing one or more ECU parameters (e.g., ECU 95_{ECM} parameters) with one or more software update parameters; and providing the notifying step only when the one or more ECU parameters correspond with the one or more software update parameters. The ECU parameters may include software and calibration part identifiers of a target ECU (i.e., the ECU for which the software update is intended; in one example, ECU_{ECM} 95). Similarly, the software update parameters may include software and calibration part identifiers associated with the particular software update. In one embodiment, the ECU parameters may only correspond with the software update parameters when the software update identifiers match the ECU parameters or when the software update parameters are within a predetermined range of values of the ECU parameters (or vice-versa). The verification process may fail when the parameters do not correspond. When the verification fails, installation will not follow.

It should be appreciated that step 310 may be performed before and after receiving consent from the user 13. Provided the verification process is validated, method 300 may proceed to step 315.

In step 315, the software update may be installed in the target ECU (e.g., ECU 95_{ECM}). This may occur automatically or without further user interaction. Techniques for installing software updates are known to skilled artisans and will not be discussed in more detail here.

Before, during, or following step 315, the user 13 may exit or egress the vehicle 12 at step 320. Performing software updates when the user is absent from the vehicle 12 may enhance the vehicle user's experience—e.g., not requiring the user to wait for the process to be completed which in some circumstances may cause user aggravation. In addition, performing software updates without interruption improves installation reliability since interruptions may produce software errors or other failures. For example, starting the vehicle ignition during the update may interrupt the update installation or cause it to fail entirely.

In step 325 which follows, the vehicle 12 may provide the user 13 with a notification or other indication that the update installation is complete. The notification may be received wirelessly via the user's mobile device 96 using the VMU 100, as will be elaborated below.

Following step 330, the user 31 may ingress or re-enter the vehicle 12 having now installed the software update. In at least one implementation, prior to re-entry, the user has received notification indicating a completed software update installation has occurred. Thus, user 13 may re-enter the vehicle 12 at least partially in response to the notification. In this implementation, the user 13 may have assurance that his/her trip will not be delayed by the vehicle's request to finish the software update installation.

After step 330, the method 300 ends. This is merely one embodiment. Other embodiments of the installation and update process also exist having various implementations of user notification.

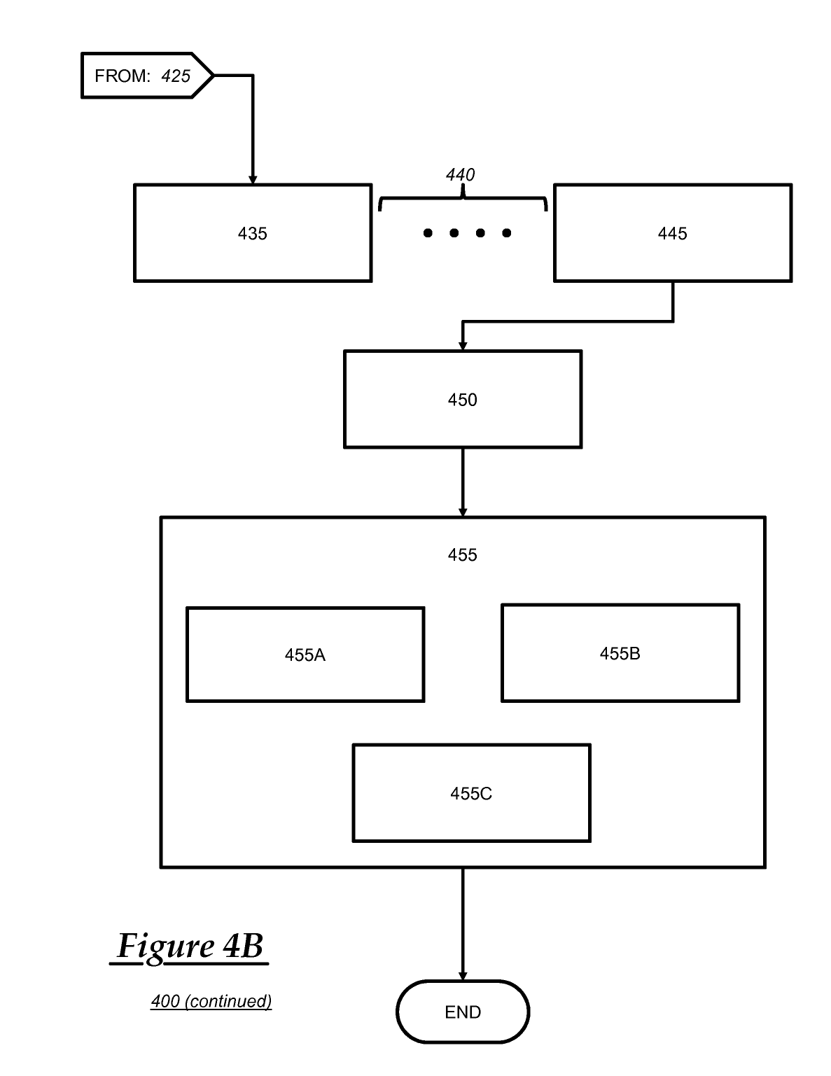

For example, in FIGS. 4A-4B illustrate another method 400. At step 405, the method begins by providing an indication that a software update is available for at least one vehicle ECU (again, a target ECU such as ECU 95_{ECM}). This step may include receiving at the telematics unit 30 a wireless transmission (e.g., packet data, SMS, etc.) from the remote server 18 indicating new update(s) are available. The telematics unit may periodically receive such indications or may request them from the remote server (e.g., call center 20). In other implementations, the VMU 100 may receive communication indicating the availability of the update. Step 405 may include downloading the software update as well. This may occur at any suitable time—e.g., when the vehicle state is powered ON or OFF. Thereafter, the method may proceed to step 410.

In step 410, the user 13 may be provided an indication or a prompt to update the target ECU(s). The indication may be any suitable audio and/or visual prompting. In at least one embodiment, the indication is presented to the user 13 via the VMU 100; e.g., on its display (e.g., 38). In one implementation, step 410 is in response to step 405. In another implementation, step 410 is omitted from method 400—e.g., in circumstances that the user indicates a desire to perform the software update for the target ECU prior to the VMU 100 providing such a prompt. In one embodiment, step 410 may provide an approximation of the time to complete an installation of the software update(s). After step 410, the method then may proceed to step 412.

In step 412, an indication from the user 13 may be received by the VMU 100 (or via other vehicle electronics 28) that the user consents to receiving the software update. It should be appreciated that any suitable form of consent is contemplated, including: tactile or touch screen inputs to the VMU 100, voice commands indicating consent, etc. Moreover, the consent may be provided while the vehicle 12 is in the powered ON state or powered OFF state. Thereafter, the method 400 may proceed to step 415.

In step 415, an indication may be received that the vehicle ignition is OFF. This indication may be received by any suitable computing device onboard the vehicle 12; in some embodiments, the telematics unit 30 receives an electrical signal or other indication from ECU 95_{ECM} representative of a vehicle ignition off condition. The method 400 then proceeds to step 420.

Step 420 may include determining how the user 13 responded to the indication of step 412 (if this was not already determined previously). If the user declined the prompt(s) to download the software update for the target ECU(s), then the method 400 may end. However, if the user accepted or consented to the prompt(s), then the method proceeds to step 425.

In step 425, it may be determined whether the vehicle is in PARK and re-check or redetermine that the vehicle ignition remains OFF. Again, one or more VSMs 42 (such as the ECM) may provide electrical signal data to a vehicle device such as the telematics unit 30 to make this determination. In at least one embodiment, both of these indications may be received via ECU 95_{ECM}. If either of a vehicle ignition OFF condition or a transmission PARK condition are not TRUE, step 425 may fail or fail to confirm the determination of step 425. In at least one embodiment, in this state, the ECU software update installation may not proceed. For example, in the event of a failure, step 425 may proceed to step 430.

In step 430, the user 13 may be provided instructions to place the vehicle in PARK and/or turn the vehicle ignition OFF. This may be any suitable audible or visual instruction (e.g., using vehicle electronics 28 and/or VMU 100). The method then may return to step 425 and re-check if both conditions are TRUE. This loop may be repeated until both conditions are confirmed. Or the loop may be repeated for a limited number of times—upon which the method simply ends if both conditions are not met. Or in another embodiment, the user may be reprompted regarding his/her desire to install the software update for the target ECU(s) (e.g., repeating and returning to step 412).

When in step 425, it is determined or confirmed that both the vehicle is in PARK and the vehicle ignition is OFF, then the method proceeds to step 435.

In step 435, the telematics unit 30 may begin to install the software update which was previously downloaded. The installing process is illustrated in step 440. And in step 445, the installing is complete. In at least one implementation, the software update packet may comprise a notification indicating a successful installation for the VMU 100 to deliver to the user's mobile device 96 once the installing process (steps 435, 440, 445) is complete.

During steps 440 and/or 445, the user may desire to change the vehicle ignition condition to ON or change the transmission condition from PARK. In one implementation, the user 13 may be warned during the attempted vehicle ignition re-start or the transmission state change. A warning message may be provided via any suitable audible or visual means (e.g., including VMU 100 and/or other electronics 28). In some implementations, there may be an emergency override to interrupt the installation enabling the user to start and drive the vehicle 12. However, in at least one embodiment, the vehicle is immobilized and actively inhibits the user from re-starting the vehicle 12 during the installation steps (440, 445). Similarly, the user may be inhibited from displacing the transmission from PARK.

When the installation is complete at step 445, the method 400 may proceed to step 450. Here, the telematics unit 30 in the vehicle 12 may provide the remote server a software update installation status indicating success or failure (e.g., via cellular communication of the telematics unit 30 or via SRWC via the telematics unit or VMU 100). Following the transmission of step 450, the method proceeds to step 455.

In step 455, a notification may be provided to the user 13. In at least some embodiments, the VMU 100 may be used to provide the notification (see steps 455A, 455B, 445C). For example, in step 455A, the notification may be displayed, provided audibly, or both by the VMU 100. This instance may be suitable when the user has remained in the vehicle 12 (or when the user is otherwise within the vehicle at the time the installation is complete).

In step 455B, the notification may be sent from the VMU 100 to the telematics unit 30 and then to the user's mobile device 96. This may occur in a variety of ways. For example, the VMU 100 may provide the notification (by wire or wirelessly) to the telematics unit 30 which in turn sends a notification to a Short Message Service Center (SMSC) which in turn sends the notification to the mobile device 96. Or for example, the VMU 100 may provide the notification (by wire or wirelessly) to the telematics unit 30 which in turn sends a notification to a remote server or computer 18 (or the call center 20) which in turn sends the notification to the mobile device 96 (e.g., by SMS, email, instant message, etc.).

In step 455C, the notification may be sent from the VMU 100 directly to the mobile device 96 (e.g., via SRWC such as Bluetooth or Wi-Fi). In other implementations, the VMU 100 may communicate with a local wireless access point (WAP) 98 before delivering the notification to the user's mobile device 96. For example, the VMU 100 may provide the notification using SRWC to the WAP 98 which in turn may provide the notification to remote server 18 (or call center 20) which in turn sends the notification to the mobile device 96 (e.g., by SMS, email, instant message, etc.). Or for example, the VMU 100 may provide the notification using SRWC to the WAP 98 which in turn may provide the notification to remote server 18 or the call center 20 which in turn sends the notification to the mobile device 96 using a software application thereon (e.g., such as RemoteLink™). Or for example, the VMU 100 may provide the notification using SRWC to the WAP 98 that is provided by the mobile device 98 itself (e.g., the mobile device is also the WAP). For example, the mobile device may be used as the hotspot and the VMU 100 may be a client to the mobile device (e.g., via Wi-Fi). Or in another embodiment, the mobile device 96 and VMU 100 communicate over Wi-Fi Direct, regardless of which device is the group owner or the group member.

Lastly, it should be appreciated that in one embodiment, the telematics unit 30 is used during the notification step (455) only when the vehicle 12 does not have an enhanced or upgraded VMU—e.g., VMU 100 may be enhanced with communication capabilities beyond conventional head units. For example, an enhanced VMU 100 may have SRWC capability as well as streaming data capability, and not merely conventional features such as AM/FM tuning and media playing (e.g., tape, CD, or MP3 players). Thus, in vehicles without the enhanced VMU 100, the telematics unit 30 may participate in the delivery of the notification (of step 455).

Thus, there have been described methods for providing a software update (e.g., for an electronic control unit or ECU in a vehicle) and providing a vehicle user a notification that the software update is completely installed. The methods improve the user's vehicle experience by performing the update(s) when the user may be absent from the vehicle and providing the notification when the user is free again to use the vehicle without affecting the updates' installation.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

1. A method of performing a software update at a vehicle, comprising the steps of:
providing a vehicle user of an update availability message associated with a vehicle electronic control unit (ECU);
receiving a vehicle user consent to install the update;
determining whether a vehicle ignition OFF condition is TRUE;
when the vehicle ignition OFF condition is TRUE, then installing the update; and
providing a notification to a mobile device associated with the vehicle user that the installation is complete.

2. The method of claim 1, further comprising:
determining whether a vehicle parked condition is TRUE; and
installing the update only when both the vehicle parked condition is TRUE and the vehicle ignition OFF condition is TRUE.

3. The method of claim 1, further comprising during the installing step, inhibiting vehicle ignition.

4. The method of claim 1, further comprising downloading the update prior to the installing step.

5. The method of claim 1, wherein the step of providing the notification further comprises notifying the vehicle user using a vehicle multi-tainment unit (VMU).

6. The method of claim 5, wherein the step of providing the notification further comprises at least one of the following:
providing the notification from the VMU to a telematics unit in the vehicle (VTU), wherein the VTU provides the notification to the mobile device;
providing the notification from the VMU to the VTU, wherein the VTU provides the notification to a remote server, wherein the remote server provides the notification to the mobile device;
providing the notification from the VMU directly to the mobile device via short range wireless communication (SRWC);
providing the notification from the VMU to a local wireless access point (WAP), wherein the WAP provides the notification to the remote server, wherein the remote server provides the notification to the mobile device; or
providing the notification from the VMU to the local WAP, wherein the local WAP is the mobile device, wherein the local WAP provides the notification via a software application on the mobile device.

7. The method of claim 6, wherein the remote server provides the notification using the software application on the mobile device.

8. The method of claim 1, wherein the notification is provided using short message service (SMS).

9. The method of claim 8, wherein the SMS notification is provided by a vehicle telematics unit (VTU) or a vehicle multi-tainment unit (VMU).

10. The method of claim 1, further comprising performing a verification process that includes:
receiving the update at a vehicle telematics unit (VTU) from a remote server;
comparing one or more ECU parameters with one or more update parameters; and
providing the update availability message only when the one or more ECU parameters correspond with the one or more update parameters.

11. A method of performing a software update at a vehicle, comprising the steps of:
receiving an update availability message associated with an update for a vehicle electronic control unit (ECU);
providing a vehicle user of the update availability message using a vehicle multi-tainment unit (VMU);
determining that a vehicle ignition OFF condition is TRUE;
prompting the user to install the update;
when an indication is received that the user wishes to install the update:
determining whether a vehicle parked condition is TRUE, and
when the vehicle ignition condition and the vehicle parked condition are TRUE, then installing the update; and
providing a notification from the VMU to a mobile device associated with the user that the installation is complete.

12. The method of claim 11, further comprising during the installing step, inhibiting vehicle ignition.

13. The method of claim 11, further comprising downloading the update prior to the installing step.

14. The method of claim 11, wherein the notification is provided using short message service (SMS).

15. The method of claim 14, wherein the SMS notification is provided via the VTU or the VMU.

16. A method of performing a software update at a vehicle, comprising the steps of:
providing an update availability message after downloading the software update using a vehicle telematics unit or a vehicle multi-tainment unit (VMU);
determining whether a vehicle ignition OFF condition is TRUE;
when the vehicle ignition OFF condition is TRUE, then installing the update;
inhibiting vehicle ignition during the installing step; and
providing a notification from the VMU to a mobile device associated with a user of the vehicle that the installation is complete.
